(19) United States
(12) Patent Application Publication
(10) Pub. No.: US 2012/0294732 A1
(43) Pub. Date: Nov. 22, 2012

(54) Pump System and Method of Use

(75) Inventors: Shane Weckerly, Bowling Green, KY (US); Larry Joe Tipton, Bowling Green, KY (US)

(73) Assignee: HOLLEY PERFORMANCE PRODUCTS, Bowling Green, KY (US)

(21) Appl. No.: 13/109,588

(22) Filed: May 17, 2011

(51) Int. Cl. F04B 49/00; F15D 1/00

(52) U.S. Cl. 417/53; 137/565.01

(57) ABSTRACT

A pump assembly and method of use is described, wherein the pump assembly includes a housing and a pump contained in the housing, wherein the pump has a performance level. The assembly may also include an electrical inlet, a fuel inlet connection, a fuel outlet connection, a pressure regulator, a final filter, an outlet check valve connected to each pump, at least one over pressure relief valve connected to the pump and an over pressure relief passage formed around the pump in the housing, an electronic controller capable of controlling the pump, a fuel filter and a pressure regulator in the housing to form a returnless fuel supply, and/or a final filter. The assembly may be used in a multiple carburetor or fuel injector applications.

### CROSS REFERENCE TO RELATED APPLICATIONS

None.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

1. Field of the Invention

The inventions disclosed and taught herein relate generally to devices pumps, and more specifically relate to high flow fuel pumps.

2. Description of the Related Art

The performance market has a segment that requires very high flow fuel pumps to supply the demands of large horsepower engines. The pumps are generally limited to these unique race engines. They contain warnings concerning their use for off-track applications due to the high current and flow recirculation requirements.

Generally, electric fuel pump designs match the peak torque of the motor performance curve with the pumping element to achieve the desired flow at a pressure point. As a result, the current suppliers develop multiple pumps to address some of the known requirements in the market by grouping their product into horsepower rating brackets.

This grouping is convenient for the supplier but can complicate the fuel management for the engine builder. If the horsepower is lower than the known bracket, the user would be forced to choose a higher flow pump and try to manage a high return flow. If the horsepower were higher than the known brackets, the user would be forced to try to stretch the pump flow by increasing the pump voltage, which then increases the flow. This option is not preferable to the pump supplier because these variables are not recognized in the pump development and pose a risk of inconsistent performance or pump damage.

Currently, this need is met with very large and very expensive electric fuel pumps. These pumps require extensive investment dollars and development time to provide a reliable product. Therefore, a need exists to find a faster, less expensive and more reliable approach that offers full-race performance and off-track use.

Additionally, some devices consist of a self-sealed, in-line pump. These devices are significantly large and heavier than is desired in all situations. These devices typically require disassembly to attach a wire harness and mount the assembly. Additionally, devices of this nature have a significant number of joints. Joints can potentially leak. Moreover, devices with self-sealed, in-line pumps typically are noisier because the pumps are exposed to the environment and are a solid mount to the inlet and outlet housings. There exists a need to provide an assembly in a smaller and lighter configuration. There also exists a need to provide a less expensive and less complex configuration for this purpose. There also exists a need to offer a more convenient wiring solution. There also exists a need to reduce the number of joints to offer less potential leak exposure. Additionally, there exists a need to contain a pump so as to reduce noise. Finally, there exists a need to provide a pump that may be suspended inside a sealed housing in a manner that reduces or eliminates metal-to-metal connections.

### BRIEF SUMMARY OF THE INVENTION

The inventions disclosed and taught herein are directed to a fuel pump that has been fully developed and endurance tested in the original equipment automotive industry.

In accordance with embodiments of the present disclosure, a pump assembly and method of use are described, wherein the pump assembly includes a housing and a pump contained within the housing, wherein the pump has a performance level. The assembly may also include an electrical inlet, a fuel inlet connection, a fuel outlet connection, a pressure regulator, a final filter, an outlet check valve connected to the pump, an over pressure relief valve connected to the pump and an over pressure relief passage formed around the pump in the housing, an electronic controller capable of controlling the pump, a fuel filter and a pressure regulator in the housing to form a returnless fuel supply, and/or a final filter. The assembly may be used in a multiple carburetor or fuel injector applications.

### BRIEF DESCRIPTION OF THE SEVERAL VIEWS OF THE DRAWINGS

The following figures form part of the present specification and are included to further demonstrate certain aspects of the present invention. The invention may be better understood by reference to one or more of these figures in combination with the detailed description of specific embodiments presented herein.

FIG. 1 illustrates a cross-sectional, partial side view of an embodiment of the invention;

FIG. 2 illustrated an expanded view of an embodiment of the invention; and

FIG. 3 illustrates a cross-sectional, partial side view of an application of an embodiment of the invention.

While the inventions disclosed herein are susceptible to various modifications and alternative forms, only a few specific embodiments have been shown by way of example in the drawings and are described in detail below. The figures and detailed descriptions of these specific embodiments are not intended to limit the breadth or scope of the inventive concepts or the appended claims in any manner. Rather, the figures and detailed written descriptions are provided to illustrate the inventive concepts to a person of ordinary skill in the art and to enable such person to make and use the inventive concepts.

### DETAILED DESCRIPTION OF THE INVENTION

The Figures described above and the written description of specific structures and functions below are not presented to limit the scope of what Applicants have invented or the scope of the appended claims. Rather, the Figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill in this art having benefit of this disclosure. It must be understood that the inventions disclosed and taught herein are susceptible to numerous and various modifications and alternative forms. Lastly, the use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the Figures and are not intended to limit the scope of the invention or the appended claims.

Applicants have created a device capable of providing a housing, which contains a fuel pump. Additionally, this invention offers the option for integrating a pressure regulator and/or final filter for complete fuel system management.

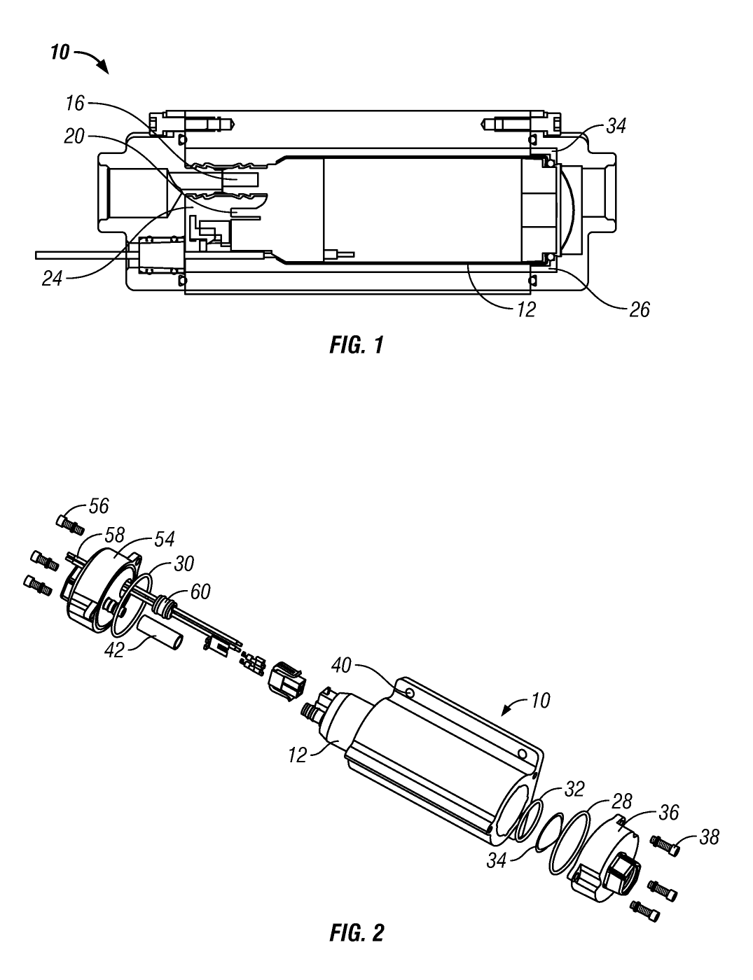

Turning now to the figures, FIG. 1 illustrates a preferred pump configuration. In this embodiment, a pump 12 is shown in a housing 10. Moreover, the pump 12 has over pressure relief valve 20. In the unlikely event of a system blockage while the pump 12 is energized, the over pressure relief valve 20 will open at safe pressure above system pressure. The fuel will be discharged into the cavity 24 around the pump 12. This fuel can then pass around the housing inlet O-ring cushion 34 through slots 26 provided and recirculate back to the inlet of the pump 12. This prevents pump damage and excessive system pressure that could result in a major fuel leak. The pump 12 has an outlet check valve 16 to hold fuel pressure when the voltage is not applied or when it is turned off.

FIG. 2 illustrates an exploded view of the housing 10. As shown before, pump 12 is shown. The housing inlet O-ring seal 28 and housing outlet O-ring seal 30 allow for the sealing of the pump 12 inside the housing 10. The pump 12 is shown with an O-ring 32 and an inlet strainer 34. The pump O-ring 32 prevents metal-to-metal vibration noise.

Moreover, the pump 12 is fitted into inlet housing 36, which may be held in place by fasteners 38. In a preferred embodiment, assembly screws may be used at the fasteners 38. The housing 10 preferably includes mounting holes 40 to allow for the assembled housing 10 to be mounted on the vehicle or other application. Turning to the outlet end of the pump 12, fuel tube 42 connects and seals pump 12 to the pump outlet, respectively.

An outlet housing 54 is shown expanded above these elements that may be held in place by fasteners 56. In a preferred embodiment, assembly screws may be used at the fasteners 56.

As shown, a bulkhead connector 60 will seal wires 58 that pass through and connect to the pump 12. This connector 60 will be held in place by the inner diameter of housing 10. Those skilled in the art will recognize that any number of wires or similar means may be connected to the pump 12 via this connector 60. Two O-rings shown on the connector 60 seal connector 60 in the mounting hole of housing 54.

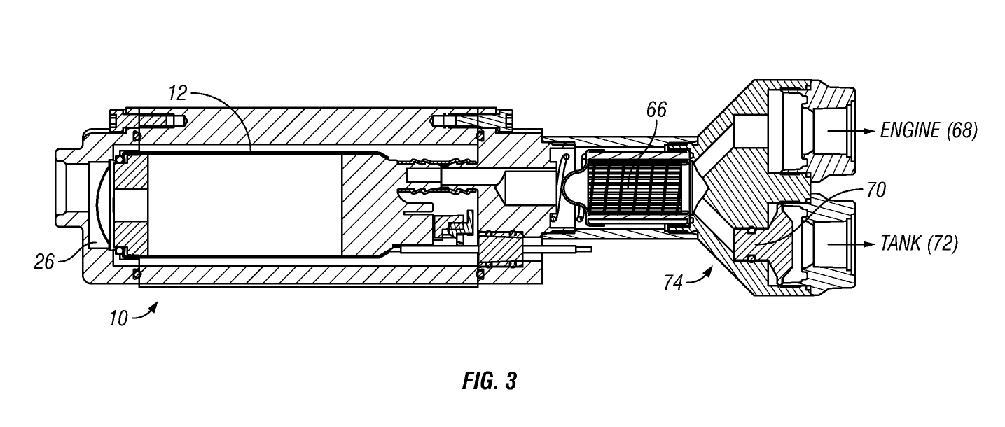

FIG. 3 illustrated a preferred embodiment in a representative configuration. In this embodiment, the housing 10 is shown such that pump 12 is positioned. The area around the pump 12 show the over pressure relief passage through a plurality of slots 26 that may be used to return fuel to the pump inlet when an over pressure relief valve is actuated by excessive pressure. The outlet of pump 12 is connected via fuel filter 66 to engine 68.

Another embodiment includes incorporating the fuel filter 66 and pressure regulator 70 into the regulator housing 74 to form a returnless fuel supply such that fuel is returned to the tank 72 via the regulator 70. This embodiment reduces the potential for heating the fuel by returning it to the tank from the pump assembly instead of the engine fuel rail. Another embodiment includes integrating the final filter 66 option only. Moreover the pump assembly may be used in a multi-carburetor application.

Further, the various methods and embodiments of the invention can be included in combination with each other to produce variations of the disclosed methods and embodiments. Discussion of singular elements can include plural elements and vice-versa.

The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions.

The inventions have been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicants, but rather, in conformity with the patent laws, Applicants intend to fully protect all such modifications and improvements that come within the scope or range of equivalent of the following claims.

What is claimed is:

1. A pump assembly comprising:
a housing;
a pump contained in the housing;
an outlet check valve connected to the pump at least one over pressure relief valve connected to the pump; and
an over pressure relief passage formed around the pump in the housing;
wherein the pump has a performance level.

2. The pump assembly of claim 1 further comprising an electrical inlet.

3. The pump assembly of claim 1 further comprising a fuel inlet connection.

4. The pump assembly of claim 1 further comprising a fuel outlet connection.

5. The pump assembly of claim 1 further comprising a pressure regulator.

6. The pump assembly of claim 1 further comprising a final filter.

7. The pump assembly of claim 1 further comprising an electronic controller.

8. The pump assembly of claim 1 wherein the pump assembly is capable of being used in a multiple carburetor or fuel injector applications.

9. The pump assembly of claim 1 further comprising a fuel filter and a pressure regulator in the housing to form a returnless fuel supply.

10. The pump assembly of claim 1 further comprising a final filter.

11. A method of using a pump assembly,
wherein the pump assembly comprises:
a housing;
a pumps contained in the housing;
an outlet check valve connected to the pump
at least one over pressure relief valves connected to the pump; and
an over pressure relief passage formed around the pump in the housing;
wherein the pump has a performance level;
which comprises the step of:
controlling the pump.

12. The method of claim 11 further comprising integrating a pressure regulator.

13. The method of claim 11 further comprising integrating a final filter.

14. The method of claim 11 further comprising a integrating a fuel filter and a pressure regulator into the housing to form a returnless fuel supply.
